(19) United States
(12) Patent Application Publication
(10) Pub. No.: US 2026/0025313 A1
(43) Pub. Date: Jan. 22, 2026

(54) A LOW LATENCY REINFORCEMENT LEARNING-SUPPORTED AND DIGITAL TWIN-ENABLED DATA TRAFFIC MANAGEMENT AND OPTIMIZATION SYSTEM FOR 6G SMART CITY INFRASTRUCTURES AND AN OPERATION METHOD THEREOF

(71) Applicant: BTS KURUMSAL BILISIM TEKNOLOJILERI ANONIM SIRKETI, Atasehir/Istanbul (TR)

(72) Inventors: Yagmur YIGIT, Bagcilar/Istanbul (TR); Hamed AHMADI, York (GB); Gökhan YURDAKUL, Üsküdar/Istanbul (TR); Berk CANBERK, Sariyer/Istanbul (TR); Trang HOANG, Hanoi (VN); Trung Quang DUONG, Belfast (GB); Özgür PALANTÖKEN, Pendik/Istanbul (TR)

(21) Appl. No.: 19/116,344

(22) PCT Filed: Dec. 29, 2023
(86) PCT No.: PCT/TR2023/051868

§ 371 Date: Mar. 27, 2025

(30) Foreign Application Priority Data
Dec. 20, 2023 (TR) 2023/017831

(51) Int. Cl. H04L 41/0823; H04L 41/14; H04L 41/16

(52) U.S. Cl. CPC H04L 41/0823; H04L 41/145; H04L 41/16

(57) ABSTRACT

The invention relates to a low-latency reinforcement learning-supported and digital twin-enabled data traffic management and optimization system for 6G smart city infrastructures and an operation method thereof. A digital twin technology-based traffic shaping infrastructure is used in the system of the invention. Thanks to the digital twin-based and reinforcement learning-supported traffic shaping infrastructure used in the system of the invention, it is ensured that the traffic is managed effectively, the delay time is minimized, and the infrastructure quality and reliability are increased.

### TECHNICAL FIELD OF THE INVENTION

The invention relates to a low-latency reinforcement learning-supported and digital twin-enabled data traffic management and optimization system for 6G smart city infrastructures and an operation method thereof. A digital twin technology-based traffic shaping infrastructure is used in the system of the invention. Thanks to the digital twin-based and reinforcement learning-supported traffic shaping infrastructure used in the system of the invention, it is ensured that the traffic is managed effectively, the delay time is minimized, and the infrastructure quality and reliability are increased.

### STATE OF THE ART

The smart cities make life easier for all stakeholders living in the city, especially city management teams. Especially the cities that grow rapidly and are exposed to the unplanned developments and immigration face the chronic problems today. The needs in basic matters such as infrastructure, superstructure, transportation, communication, education and health are growing rapidly and are far exceeding the service supply. For this reason, there are new searches outside of the traditional problem-solving methods. Along with these developments, the rapid changes and emerging developments in the field of technology enable the city problems to be addressed with a technology and innovation-based approach and produce more precise and faster solutions.

Today, the different algorithms and applications are used for the data traffic management in existing smart city infrastructures in the solution of the transmission problems that occur as a result of the increase in traffic density. Although the Ethernet-based solutions, especially those offered by the systems in which said algorithms and applications are used, are widely preferred to meet the communication requirements, these existing solutions are insufficient to manage traffic that requires time sensitivity. The Time-Sensitive Networking (TSN) standards include the efforts to develop the Ethernet technology for the time-sensitive communication. However, TSN solutions can be difficult to deal with the unexpected and time-sensitive traffic situations and require a technique to accurately classify the traffic status changes without stopping traffic or pausing the system. The instantaneous data from the medical sensors in a smart city network can be given as an example. Some of this data needs to be communicated urgently because it comprises the instant and serious information about the patient health. However, if such data is not prioritized within the network traffic, the transmission time may be delayed or the data may be lost. For example, during a rush hour, the medical sensor data can be jammed in other low-priority traffic, which can cause serious damage to the patient care. Such situations highlight the serious consequences that occur when the network traffic fails to meet the time-sensitive requirements, and the importance of prioritization. Additionally, in the state of the art, the traffic shaping algorithms are also available, such as Leaky Bucket Shaper, Token Bucket Shaper, Time-Aware Shaper-TAS, Credit-Based Shaper-CBS and Asynchronous Traffic Shaper-ATS. While some of these algorithms can be effective in certain situations, they may cause deficiencies and difficulties in some situations. For example, while the system containing the TAS method regulates the data traffic with Gate Control List (GCLs) determined by 802.1Qbv using a time-division approach, it can lead to complexity in practice due to the difficulties such as the creation of GCLs and time synchronization. In addition, the system comprising the TAS method is not enabled to manage non-periodic traffic.

The traffic shaping algorithms typically prioritize the traffic. The high-priority class generally represents the data traffic that is more critical or time-sensitive. For example, the urgent medical data or security camera footage may be a high priority, while a low-priority class represents less critical or less time-sensitive traffic. In another example, the general web browsing or e-mail traffic may be a low priority. The traffic classifications in this network are intended to distribute the bandwidth of the traffic management algorithms in the most effective way.

Leaky Bucket Shaper, another algorithm used in traffic shaping systems in the state of the art, is an algorithm that regulates the data traffic and prevents the data loss. Although it regulates traffic by transmitting the data stream at a constant speed and averaging the data rate, it is not effective enough in the irregular data flows.

Token Bucket Shaper, which is another algorithm used in the traffic shaping systems in the state of the art, is based on the Token Bucket Shaper algorithm and uses tokens to guarantee the service quality, although it is a structure that regulates traffic according to the factors in the network and helps reduce the data loss and jitter. However, the systems using the Token Bucket Shaper algorithm cause the data loss in overloads.

The Credit-Based Shaper (CBS), another algorithm used in the traffic shaping systems in the state of the art, is an algorithm defined by IEEE 802.1Qav that allocates a bandwidth to priority classes using the credit system. Although said algorithm helps prevent the low-priority classes from starvation (low-priority traffic not reaching sufficient resources or being transmitted at lower speeds) while regulating the high-priority traffic, it is designed to manage the high-priority traffic and has a greater impact on the low-priority traffic. Asynchronous Traffic Shaper (ATS), which is another algorithm used in the traffic shaping systems in the state of the art, is an algorithm defined by IEEE 802.1Qcr and does not require the time synchronization. Although ATS is a flexible traffic management algorithm that does not require the time synchronization, it is not ideal for managing the high-priority traffic.

Due to the reasons such as the limitations and inadequacies of the traffic shaping systems in the state of the art, in which various algorithms are used, the difficulties in efficiently managing the dynamic traffic in 6G smart cities, the absence of the flexible and smart solutions for dealing with the complex situations such as time-sensitive, non-periodic and unexpected but critical data traffic, and the absence of a system in the state of the art, comprising an effectively optimized traffic management algorithm to ensure the connection quality, reliability and latency of the infrastructure, it has become necessary to introduce a data traffic management and optimization system and an operation method thereof in the city infrastructures in which all these problems are eliminated.

### SUMMARY AND OBJECTS OF THE INVENTION

The invention describes a low-latency reinforcement learning-supported and digital twin-enabled data traffic management and optimization system for 6G smart city infrastructures and an operation method thereof. A digital twin technology-based traffic shaping infrastructure is used in the system of the invention. Thanks to the digital twin-based and reinforcement learning-supported traffic shaping infrastructure used in the system of the invention, it is ensured that the traffic is managed effectively, the delay time is minimized, and the infrastructure quality and reliability are increased. In addition, the deep reinforcement learning-based classification method and smart gate control mechanism are used in the system of the invention. Thanks to the use of the deep reinforcement learning-based classification method and the smart gate control mechanism in the system of the invention, the smart city infrastructures are ensured to work more effectively and robustly. For example, the deep reinforcement learning-based classification method of the system recognizes the different types of traffic and dynamically manages traffic. The smart gate control mechanism, on the other hand, increases the efficiency of the network by quickly transmitting the high-priority traffic such as emergency traffic. In this way, the system of the invention works more effectively and robustly than other systems.

An object of the invention is to provide a low-latency reinforcement learning-supported and digital twin-enabled data traffic management and optimization system for 6G smart city infrastructures that enable the effective management of the unexpected and time-sensitive network traffic. For this purpose, the system uses the deep reinforcement learning techniques that provide low latency in order to react quickly to the instant traffic changes and to route the traffic intelligently. A system that enables the effective management of the unexpected and time-sensitive network traffic is provided by the deep reinforcement learning (DRL)-based classification module in the invention.

Another object of the invention is to provide a low-latency reinforcement learning-supported and digital twin-enabled data traffic management and optimization system for 6G smart city infrastructures that reduce the system complexity without using a gate control list and enable a more effective gate control. The smart gate control mechanism module in the invention eliminates the need for the gate control lists and minimizes the system complexity. The smart gate control mechanism module manages the data frames based on the priority traffic order and uses an artificial neural network. In this way, the data frames are transferred effectively and in a prioritized manner, and the traffic management becomes more efficient. This module has the ability to open and close the smart switch gates based on the traffic status and intelligently manages the traffic without stopping it. The system of the invention works on the basis of TSN standards. In this way, the ability to manage the time-aware traffic is increased. The digital infrastructure benefits from the Digital Twin (DT) technology. A digital twin infrastructure-based traffic shaping configuration is a digital copy that virtually represents and monitors the real-world processes, objects, and systems. DT allows the real-time monitoring and analysis of components and traffic in the smart city infrastructures. In this way, the status and characteristics of the traffic can be understood more accurately. In the state of the art, the flexible and smart solutions are needed to deal with the complex situations such as data traffic, and the digital infrastructure offered by the system of the invention, i.e., the traffic shaping structure, regulates the data traffic between the different devices in the infrastructure. The digital infrastructure of the system of the invention works together with the existing infrastructures to intelligently manage the dynamic and complex traffic. The deep reinforcement learning (DRL)-based classification method, which is the main element in the system of the invention, provides a solution to the difficulties of TSN in managing the time-critical traffic status changes. Thanks to the DRL, the best classification decision can be made according to various traffic status. In addition, thanks to the time synchronization module and smart gate control mechanism module used in the system of the invention, a machine learning-based solution is used instead of the traditional gate control list or time synchronization. In this way, the data traffic is dynamically regulated and it is ensured that the low-priority traffic does not experience starvation.

The invention provides a low-latency reinforcement learning-supported and digital twin-enabled data traffic management and optimization system for 6G smart city infrastructures that do not cause the data loss problems even in overloads and enable the management of the high-priority traffic. In the invention, the introduction of a low-latency reinforcement learning-supported and digital twin-enabled data traffic management and optimization system for 6G smart city infrastructures that do not cause the data loss problems even in overloads is provided by the deep reinforcement learning (DRL)-based classification module, the module for the data frames classified based on their priorities and the data transmission selection module. To this end, the system minimizes the data loss by effectively managing the data traffic even in the overloaded situations, and prioritizes the high-priority traffic and secures its transmission. For example, even in heavy traffic situations, the data is prioritized and transmitted, and the emergency traffic is transmitted with priority over other traffic.

With the invention, an integrated and optimized infrastructure is realized, which combines the digital and physical worlds to meet the needs of the rapidly growing population and increasing technology of the smart cities. Said infrastructure is provided thanks to a low-latency reinforcement learning-supported and digital twin-enabled data traffic management and optimization system of the invention for 6G smart city infrastructures. Especially in densely populated regions, the efficient and robust processing of the smart infrastructure is critical to cope with rapidly increasing data traffic and demands. In this context, the digital infrastructure offered by the system of the invention, i.e., the traffic shaping structure, regulates the data traffic between the different devices in the infrastructure.

### DESCRIPTION OF THE DRAWINGS

FIG. 1 shows a representative view of the system of the invention.

FIG. 2 shows the flow diagram of the method of the invention.

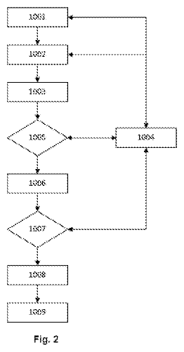

FIG. 3 shows an overview diagram of the system of the invention

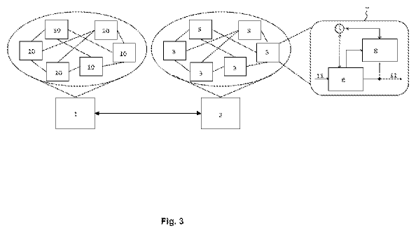

### DESCRIPTION OF THE REFERENCES IN DRAWINGS

1. Physical network module
2. Digital twin network module
3. Smart switch twin module
4. Smart switch service layer module
5. Time synchronization module
6. Deep reinforcement learning (DRL)-based classification module
7. Module for data frames classified based on their priority
8. Smart gate control mechanism module
9. Data transmission selection module
10. Smart switch
11. Data frame
1001. Creating a digital twin of the physical network components
1002. Collecting the real-time data via the digital twin network
1003. Monitoring the status of the physical switch with the smart switch twins
1004. Ensuring the time synchronization
1005. Using a DRL-based classification method for the smart traffic management
1006. Classifying the data frames based on their priority
1007. Using the smart gate control mechanism
1008. Determining the transmission path of the data traffic
1009. Opening and closing the gates based on the traffic priority status

### DETAILED DESCRIPTION OF THE INVENTION

The invention relates to a low-latency reinforcement learning-supported and digital twin-enabled data traffic management and optimization system for 6G smart city infrastructures and an operation method thereof. A digital twin technology-based traffic shaping infrastructure is used in the system of the invention. Thanks to the digital twin-based and reinforcement learning-supported traffic shaping infrastructure used in the system of the invention, it is ensured that the traffic is managed effectively, the delay time is minimized, and the infrastructure quality and reliability are increased. In addition, the deep reinforcement learning-based classification method and smart gate control mechanism are used in the system of the invention. Thanks to the use of the deep reinforcement learning-based classification method and the smart gate control mechanism in the system of the invention, the smart city infrastructures are ensured to work more effectively and robustly.

A low-latency reinforcement learning-supported and digital twin-enabled data traffic management and optimization system of the invention for 6G smart city infrastructures comprises
a physical network module (1), which transmits the data as the main carrier of the smart city infrastructure and transmits the data from the wired or wireless network components, sensors and other devices over the physical network,
a digital twin network module (2), which creates a virtual copy of the objects in the physical world, is used to collect and analyze the real-time data and track the status of objects, and performs the interaction and tracking between the real world and the digital world,
a smart switch twin module (3), which monitors the status of the physical smart switches as a virtual representation of the physical smart switches in the physical network module (1) and optimizes their management,
a smart switch service layer module (4), which performs the physical smart switch management of the smart switch twins, classifies and prioritizes the data traffic, manages the traffic that requires the time precision, and selects the data transmission,
a time synchronization module (5), which enables the synchronization of the times of the devices in the network, ensuring that all devices have a common time reference and synchronization,
a deep reinforcement learning (DRL)-based classification module (6), which classifies the data frames based on the time precision and priority status, minimizes the average latency to be three times better than the Time-Aware Shaper (TAS) and Time-Sensitive Networking (TSN) key including the frame, models the algorithm decision-making process using an MDP (Markov Decision Process)-based approach, and enables the learning using the deep reinforcement learning (DRL) techniques for the optimization, and which is trained by identifying the reward function and the loss function,
a module for data frames (7) classified based on their priority, which groups the data frames classified by the Deep Reinforcement Learning (DRL)-based classification module (6) based on their priority, separates and manages the time- sensitive priority data traffic from other data types,
a smart gate control mechanism module (8), which manages the data frames based on the priority traffic order and uses an artificial neural network, transfers the data frames in a prioritized manner, and opens and closes the gates based on the traffic status,
a data transmission selection module (9), which determines the most appropriate path of the data traffic and selects the transmission path of data on the physical network, taking into account time synchronization and the status of priority traffic, and provides the data traffic management,
a physical smart switch (10) paired with the digital twins, which enables the communication between the network devices in the physical network module (1) and controls the transmission of the data frames,
a data frame (11), which is the basic data unit that carries the information within the network and is the basic building block of the traffic management.

An operation method of the low-latency reinforcement learning-supported and digital twin-enabled data traffic management and optimization system of the invention for 6G smart city infrastructures comprises the steps of
i. creating a digital twin of the physical network components (1001) and performing the time synchronization (1004),
ii. collecting the real-time data via the digital twin network module (2) (1002) and performing the time synchronization (1004),
iii. monitoring the status of the physical switches with the smart switch twin module (3) (1003)
iv. implementing a deep reinforcement learning (DRL)-based classification module (6) for the smart traffic management (1005) and performing the time synchronization (1004),
v. classifying the data frames based on their priority (1006),
vi. using the smart gate control mechanism module (8) (1007) and performing the time synchronization (1004),
vii. determining the transmission path of the data traffic (1008),
viii. opening or closing the gates based on the traffic priority status (1009).

The physical network module (1) and the digital twin network module (2) constitute the basic building blocks of the digital infrastructure. The physical network module (1) has a physical layer comprising the real-world network objects. The digital twin network module (2), on the other hand, hosts the digital twins of these physical network objects and works with the service layers. The time synchronization module (5) ensures that the physical network module (1) and the digital twin network module (2) work synchronously. In this way, the status of the physical objects is accurately and reliably reflected in the digital twins. The deep reinforcement learning (DRL)-based classification module (6) manages the classification and prioritization of the data traffic. The traffic data received via the smart switches (10) and copied in the smart switch twin module (3) are processed separately by the smart switch service layer module (4) and classified by defining the time intervals. In this way, the data traffic is effectively managed and classified.

The module (7) for data frames classified based on their priority refers to the arrangement of the classified data frames as a result of the DRL-based classification module (6) in the specified priority order. In this way, the data frames are transmitted in accordance with their priorities. The smart gate control mechanism module (8) determines the transmission priority of the classified squares. Said mechanism uses an artificial neural network to decide on the permissions of the traffic queues and ensures that the data frames are transmitted effectively based on their priority, and at the same time takes into account the cases in which the data frames interfere with each other. The data transmission selection module (9) refers to the selection of the data frames determined by the smart gate control mechanism module (8) for the correct data transmission to a specific destination. This information is transmitted to the smart switches (10) through the smart switch twin module (3), enabling the transmission of data in the physical network.

The digital infrastructure system works effectively with the combination of the physical and digital twin networks. The deep reinforcement learning (DRL)-based classification module (6) manages the classification of the data frames and the smart gate control mechanism module (8) manages the intelligent transmission of the classified data frames. Thanks to this integrated approach, the network resources are managed efficiently while the cyber-physical interaction is achieved.

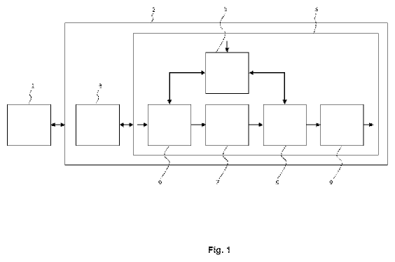

In order to better understand the operation of the invention, the interaction of the system components must be considered. A smart city infrastructure can be taken as an example. In this infrastructure, the traffic lights, security cameras, sensors, and other devices are constantly generating data. The physical network module (1) comprises the real-time data from the different sensors and devices and reflects the data in the digital world through the digital twin network module (2). Thanks to this reflection, the interaction between the physical world and the digital world is provided. The smart switch twin module (3) monitors and manages the status of the physical smart keys, thus controlling and optimizing the network traffic. The deep reinforcement learning-based classification module (6) classifies and prioritizes traffic, which ensures the effective management of data traffic. The smart gate control mechanism module (8), which determines the priority traffic order, manages the traffic flow and transfers the data frames in the determined priority order. FIG. 1 shows the operation of the system in detail visually. Thus, thanks to this sample application, it is possible to better understand how the invention works. Deep reinforcement learning (DRL) is a method used to model and optimize the algorithm decision-making processes. For example, an object of the invention is to learn what actions to take to classify and prioritize traffic by using DRL in the data traffic management. This learning process takes place by defining and iteratively updating the reward and loss functions. As a result, the DRL ensures that the data traffic is effectively managed and prioritized in the invention.

6G technology has great potential for the smart cities by offering the features such as low latency and high data rates. The applications of 6G technology require particularly a fast and reliable data transmission. These features of 6G are in line with the objects of the invention to enable a rapid management and processing of the data traffic. The speed and capacity of 6G technology effectively provide support to meet the requirements of the smart city infrastructure of the invention and ensure an efficient traffic management. In this regard, the use of 6G technology plays an important role in the invention.

1. A low-latency reinforcement learning-supported and digital twin-enabled data traffic management and optimization system for 6G smart city infrastructures, wherein it comprises
a physical network module (1), which transmits the data as the main carrier of the smart city infrastructure and transmits the data from the wired or wireless network components, sensors and other devices over the physical network,
a digital twin network module (2), which creates a virtual copy of the objects in the physical world, is used to collect and analyze the real-time data and track the status of objects, and performs the interaction and tracking between the real world and the digital world,
a smart switch twin module (3), which monitors the status of the physical smart switches as a virtual representation of the physical smart switches in the physical network module (1) and optimizes their management,
a smart switch service layer module (4), which performs the physical smart switches management of the smart switch twins, classifies and prioritizes the data traffic, manages the traffic that requires the time precision, and selects the data transmission,
a time synchronization module (5), which enables the synchronization of the times of the devices in the network, ensuring that all devices have a common time reference and synchronization,
a deep reinforcement learning (DRL)-based classification module (6), which classifies the data frames based on the time precision and priority status, minimizes the average latency to be three times better than the Time-Aware Shaper (TAS) and Time-Sensitive Networking (TSN) key including the frame, models the algorithm decision-making process using an MDP (Markov Decision Process)-based approach, and enables the learning using the deep reinforcement learning (DRL) techniques for the optimization, and which is trained by identifying the reward function and the loss function,
a module for data frames (7) classified based on their priority, which groups the data frames classified by the Deep Reinforcement Learning (DRL)-based classification module (6) based on their priority, separates and manages the time-sensitive priority data traffic from other data types,
a smart gate control mechanism module (8), which manages the data frames based on the priority traffic order and uses an artificial neural network, transfers the data frames in a prioritized manner, and opens and closes the gates based on the traffic status,
a data transmission selection module (9), which determines the most appropriate path of the data traffic and selects the transmission path of data on the physical network, taking into account time synchronization and the status of priority traffic, and provides the data traffic management,
a physical smart switch (10) paired with the digital twins, which enables the communication between the network devices in the physical network module (1) and controls the transmission of the data frames,
a data frame (11), which is the basic data unit that carries the information within the network and is the basic building block of the traffic management.

2. An operation method of the low-latency reinforcement learning-supported and digital twin-enabled data traffic management and optimization system for 6G smart city infrastructures, wherein it comprises the steps of
i. creating a digital twin of the physical network components (1001) and performing the time synchronization (1004),
ii. collecting the real-time data via the digital twin network module (2) (1002) and performing the time synchronization (1004),
iii. monitoring the status of the physical switches with the smart switch twin module (3) (1003)
iv. implementing a deep reinforcement learning (DRL)-based classification module (6) for the smart traffic management (1005) and performing the time synchronization (1004),
v. classifying the data frames based on their priority (1006),
vi. using the smart gate control mechanism module (8) (1007) and performing the time synchronization (1004),
vii. determining the transmission path of the data traffic (1008),
viii. opening or closing the gates based on the traffic priority status (1009).
